(19) United States
(12) Patent Application Publication
(10) Pub. No.: US 2021/0283441 A1
(43) Pub. Date: Sep. 16, 2021

(54) FIRE EXTINGUISHING SYSTEM FOR LITHIUM BATTERY ENERGY STORAGE UNIT BASED ON STAGEWISE WARNING AND MULTIPLE SPRAYING

(71) Applicant: Huazhong University of Science and Technology, Wuhan (CN)

(72) Inventors: Yuancheng CAO, Wuhan (CN); Weixin ZHANG, Wuhan (CN); Shun TANG, Wuhan (CN)

(21) Appl. No.: 17/338,223

(22) Filed: Jun. 3, 2021

(30) Foreign Application Priority Data
Jul. 22, 2020 (CN) 202010713505.8

(51) Int. Cl. A62C 3/16; A62C 37/14

(52) U.S. Cl. CPC A62C 3/16; G08B 21/16; A62C 37/14

(57) ABSTRACT

A fire extinguishing system for a lithium battery energy storage unit based on stagewise warning and multiple spraying includes a power management system, a warning control system connected to the power management system and a fire extinguishing device connected to the warning control system. The fire extinguishing device is externally connected to a temperature-sensing fire detection tube, a large-flow release pipeline and a local release pipeline. The warning control system is externally connected to a local data collection module and a lithium battery energy storage pack. The fire extinguishing system of this application is designed to perform cyclical detection according to fire signals, in which a starting signal can be repeatedly sent to achieve multiple starting, so as to suppress a lithium battery fire for a long time and solve the problem of re-ignition.

### CROSS-REFERENCE TO RELATED APPLICATIONS

This application claims the benefit of priority from Chinese Patent Application No. 202010713505.8, filed on Jul. 22, 2020. The content of the aforementioned application, including any intervening amendments thereto, is incorporated herein by reference in its entirety.

### TECHNICAL FIELD

This application relates to fire extinguishing devices, and more particularly to a fire extinguishing system for a lithium battery energy storage unit based on stagewise warning and multiple spraying.

### BACKGROUND

Due to the characteristics of large energy density, high output power and long service life, lithium battery has been widely applied in the fields of transportation power, power storage and mobile communications in recent years and has become an important part of China's energy strategic emerging industries. However, the in-depth application of the lithium battery in engineering also brings an increase in the possibility of the lithium battery fire. Considering the high energy density, the lithium battery is prone to producing a lot of heat especially in the case of overheat, short-circuit and squeezing, which will cause a chain reaction of internal electrode materials and electrolyte, thereby causing thermal runaway and even large-scale fire and explosion accidents.

At present, more energy has been stored in a relatively small space to improve the energy density, and the space has been squeezed to an extent where the fire safety cannot be ensured. For example, in a 40-foot energy storage container with a 2 MWh battery capacity, cells in the lithium battery pack are tightly arranged, such that the chain-fire spread and explosion will be easily triggered once the thermal runaway occurs. A traditional fire warning system fails to detect the thermal runaway of the lithium battery in time, so that the fire has spread over a large area when the fire is sensed by a temperature or smoke sensor. In addition, a fire extinguishing agent fails to bypass a battery rack, a battery pack and a module set for the first time to extinguish the fire near the cell under thermal runaway by using a traditional release technology. Seriously, during the thermal runaway of the lithium battery, the heat is continually produced, which will easily cause re-ignition. Traditionally, the fire extinguishing agent is released uniformly in the entire space, and the fire extinguishing agent sinks under the action of gravity, so that it fails to maintain an effective suppression concentration for a long period of time near the battery with thermal runaway, failing to enable the efficient and accurate utilization of the fire extinguishing agent.

There is a great demand to develop a fire extinguishing device used for a lithium battery energy storage system that has characteristics of large cell volume, rapid fire spread, continuous heat generation from the inside out heating and easy re-ignition.

### SUMMARY

An object of this application is to provide a fire extinguishing system for a lithium battery energy storage unit based on stagewise warning and multiple spraying to overcome the defects in the prior art. The system of the disclosure can stabilize a pressure in a fire detection tube and can also increase a delivery distance of a fire extinguishing agent and expand the protection range of the fire detection tube.

Technical solutions of this application are described as follows.

This application provides a fire extinguishing system for a lithium battery energy storage unit based on stagewise warning and multiple spraying, comprising:

a power management system;

a warning control system connected to the power management system; and

a fire extinguishing device connected to the warning control system;

wherein the fire extinguishing device is externally connected to a temperature-sensing fire detection tube, a large-flow release pipeline and a local release pipeline; and the warning control system is externally connected to a local data collection module and a lithium battery energy storage pack.

In an embodiment, the power management system is configured to collect a temperature T and a voltage U of a cell in the lithium battery energy storage pack in real time and transmit the temperature T and the voltage U to the warning control system.

In an embodiment, the warning control system is configured as an operation and processing center of the fire extinguishing system; and the warning control system is configured to collect internal data of the power management system to analyze temperature and voltage data of a cell of the lithium battery energy storage pack, collect data of the local data collection module to indirectly collect temperature data of thermal runaway of the lithium battery energy storage pack and collect a fire alarm signal sent from a smoke alarm, a combustible gas detector and a manual control module to control actuation of the fire extinguishing device and output of a signal linkage module through a series of logical operations.

In an embodiment, the fire extinguishing device is provided with a plurality of solenoid valves; wherein the plurality of solenoid valves are configured to be switched on and off according to an instruction of the warning control system to selectively release a fire extinguishing agent from the fire extinguishing device.

In an embodiment, the temperature-sensing fire detection tube is a temperature-sensitive pressure-resistant hose; wherein a burst temperature of the temperature-sensing fire detection tube is 120-180° C.; an inside of the temperature-sensing fire detection tube is configured to transport the fire extinguishing agent; and a bearable pressure of the temperature-sensing fire detection tube is 5-10 MPa.

In an embodiment, the local release tube is provided near the lithium battery energy storage pack; and the warning control system is configured to send an actuating instruction to allow the fire extinguishing agent to be released from the local release tube to enter the lithium battery energy storage to perform fire extinguishment.

In an embodiment, the local data collection module is configured to convert a single point signal of a thermal runaway sensor into a bus signal with address and transmit the bus signal to the warning control system through RS485, CAN and Ethernet; and the warning control system is configured to set a control signal of the plurality of solenoid valves through the RS485, CAN and Ethernet to control the plurality of solenoid valves to be switched on and off, so as to achieve point-to-point signal collection and control of the plurality of solenoid valves.

In an embodiment, the combustible gas detector is configured to detect a combustible gas released by thermal runway of a lithium battery; wherein the combustible gas is carbon monoxide, hydrogen or a combination thereof; and when the combustible gas reaches a preset concentration, a fire warning signal is output.

In an embodiment, the manual control module is provided with a starting switch and a reset switch; when a fire is observed, the starting switch is manually pressed to allow the warning control system to directly start the fire extinguishing device to directly release the fire extinguishing agent through the large-flow release pipeline; and when an operation is required to be canceled, the reset switch is manually pressed to reset all operations and alarms.

In an embodiment, the signal linkage module is configured to have a linkage with a third-party alarm device when the fire extinguishing agent is released; and the third-party alarm device comprises a sound-light alarm, an alarm bell, a fire extinguishing agent and a release indicator light.

In an embodiment, the temperature-sensing fire detection tube is a hose, on which a burst will appear when a set temperature is reached. Specifically, when the lithium battery energy storage pack reaches the set temperature, the burst will be formed on the fire detection tube and a pressure in the fire detection tube is released through the burst. At this time, after the fire extinguishing device is started, one part of the fire extinguishing agent is released from the burst to accurately extinguish the fire and the other part of the fire extinguishing agent is released through the large-flow release pipeline for pure temperature-sensing emergency start protection.

In another aspect, this application also provides a fire extinguishing method using the above fire extinguishing system, which is specifically described as follows.

First-Stage Warning

The first-stage warning is performed based on a linkage between the warning control system and the power management system.

(1) The warning control system collects the temperature and the voltage of the cell in the lithium battery energy storage pack in real time through the power management system.

(2) The warning-control system analyzes conditions of the thermal runaway of the lithium battery energy storage pack, that is, Tx≥T0 and Ux≤U0, where T0 is a boundary temperature of the thermal runaway and U0 is a boundary voltage of the thermal runaway.

(3) The warning control system outputs an instruction to the fire extinguishing device to switch on a solenoid valve on a local header pipeline and a local solenoid valve, so as to release the fire extinguishing agent.

(4) A reset instruction is given after the fire extinguishing device releases the fire extinguishing agent, and the warning control system resets all solenoid valves on the fire extinguishing device to complete one release of the fire extinguishing agent, where the duration of one release of the fire extinguishing agent is determined according to actual engineering needs. When the warning control system again detects through the power management system that the temperature and voltage meet the boundary conditions of the thermal runaway, steps (2-4) are repeated to achieve multiple spraying of the fire extinguishing agent.

Second-Stage Warning

The second-stage warning is performed based on a linkage of the warning control system and the thermal runaway sensor.

(1) The warning control system collects data of the thermal runaway sensor in real time through the local data collection module.

(2) The warning control system analyzes the data of the thermal runaway sensor to determine whether the lithium battery energy storage pack meets the boundary conditions of the thermal runaway, that is, Trx≥Tr0 and Krx≥Kr0, where Tr0 is a boundary temperature of the environment of the pack and Kr0 is a heating rate of the ambient temperature of the pack when the thermal runaway occurs in the battery.

(3) The warning control system outputs an instruction to the fire extinguishing device to start the solenoid valve on the local header pipeline and the local solenoid valve, so as to release the fire extinguishing agent.

(4) A reset instruction is given after the fire extinguishing device releases the fire extinguishing agent, and the warning control system resets all solenoid valves on the fire extinguishing device to complete one release of the fire extinguishing agent, where the duration of one release of the fire extinguishing agent is determined according to actual engineering needs. When the warning control system again detects through the local data collection module that the temperature and heating rate meet the boundary conditions of the thermal runaway, steps (2-4) are repeated to achieve multiple spraying of the fire extinguishing agent.

Third-Stage Warning

The warning control system determines whether there is a fire hazard through the smoke detector and the combustible gas detector, and then comprehensively analyzes the fire hazard and the specific location thereof through the temperature signal Tx of the power management system and Trx signal of the thermal runaway sensor. The specific operation is described as follows.

(1) The warning control system determines the existence of a fire hazard through the smoke detector and the combustible gas detector.

(2) The warning control system detects the cell temperature Tx≥T0 or Trx≥Tr0 and locates the fire in the x^{th} pack.

(3) The warning control system outputs an instruction to the fire extinguishing device to start the solenoid valve on the local header pipeline and the x^{th} local solenoid valve, so as to release the fire extinguishing agent.

(4) A reset instruction is given after the fire extinguishing device releases the fire extinguishing agent, and the warning control system resets all solenoid valves on the fire extinguishing device to complete one release of the fire extinguishing agent, where the duration of one release of the fire extinguishing agent is determined according to actual engineering needs. When the warning control system again detects that the temperature meets the boundary conditions of the thermal runaway, steps (2-4) are repeated to achieve multiple spraying of the fire extinguishing agent.

Compared to the prior art, this application has the following beneficial effects.

The fire extinguishing system of this application is designed to perform cyclical detection according to the fire signals, in which the starting signal can be repeatedly sent to achieve multiple starting, so as to suppress a lithium battery fire for a long time and solve the problem of re-ignition. The warning control system cooperates with the power management system to determine whether there is the thermal runaway in the battery by online real-time analysis of voltage and temperature changes in the cell, so as to achieve the pre-warning of the fire risk, improve the warning response speed and suppress the fire in an initial stage. The location of the fire can be accurately determined by analyzing an address code of the thermal runaway cell and an address code of the thermal runaway sensor, and the corresponding local solenoid valve is controlled to release the fire extinguishing agent, which achieves accurate detection and fire extinguishment and improves the fire extinguishing efficiency. The fire is accurately located and analyzed through real-time analysis of the temperature change rate of the cell and the data change rate of the thermal runaway sensor, which can improve the accuracy of fire recognition and reduce the false alarms. In addition, the fire extinguishing system is further provided with the smoke detector and the combustible gas detector to detect the thermal runaway of the lithium battery, and further, based on the temperature signals, the fire can be accurately positioned, so as to realize the precise fire detection and extinguishing of the lithium battery and improve the warning response speed and the fire positioning accuracy.

### DETAILED DESCRIPTION OF EMBODIMENTS

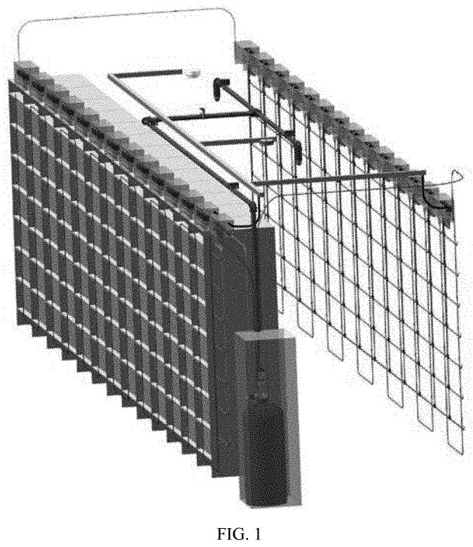

FIG. 1 is a structure diagram of a fire extinguishing system for a lithium battery energy storage unit based on stagewise warning and multiple spraying according to an embodiment of the present disclosure.

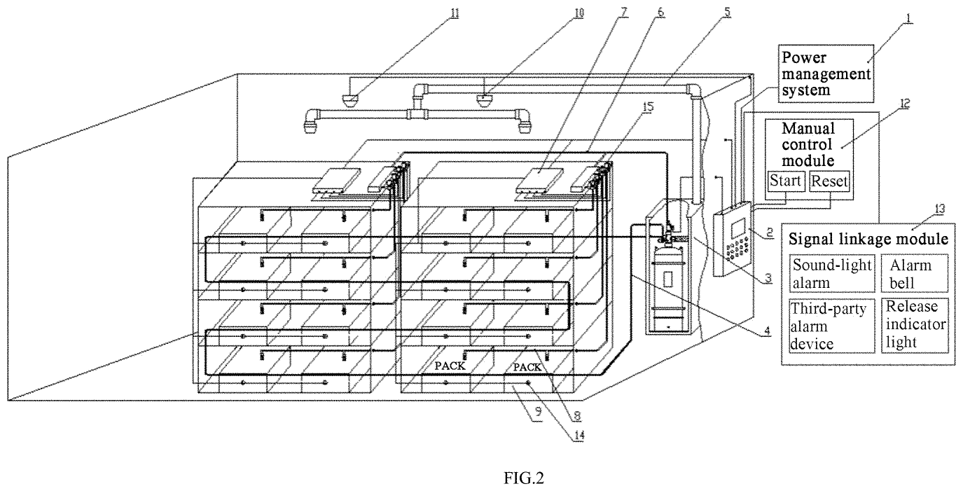

FIG. 2 schematically shows a working principle of the fire extinguishing system according to an embodiment of the present disclosure.

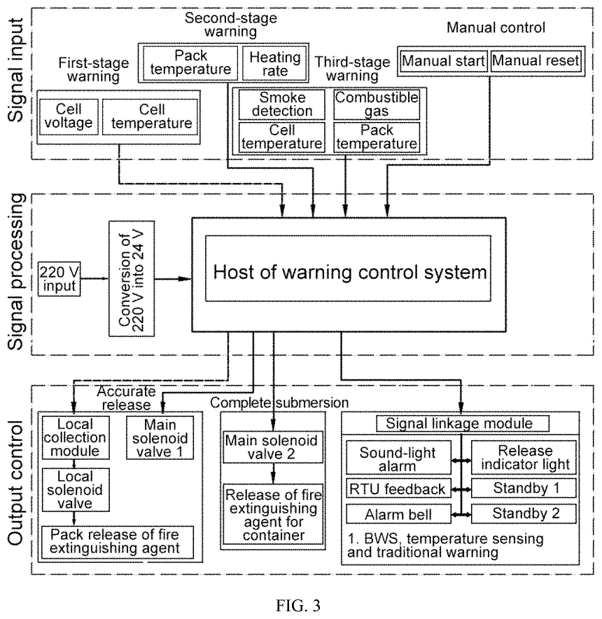

FIG. 3 schematically shows an overall work flow of the fire extinguishing system according to an embodiment of the present disclosure.

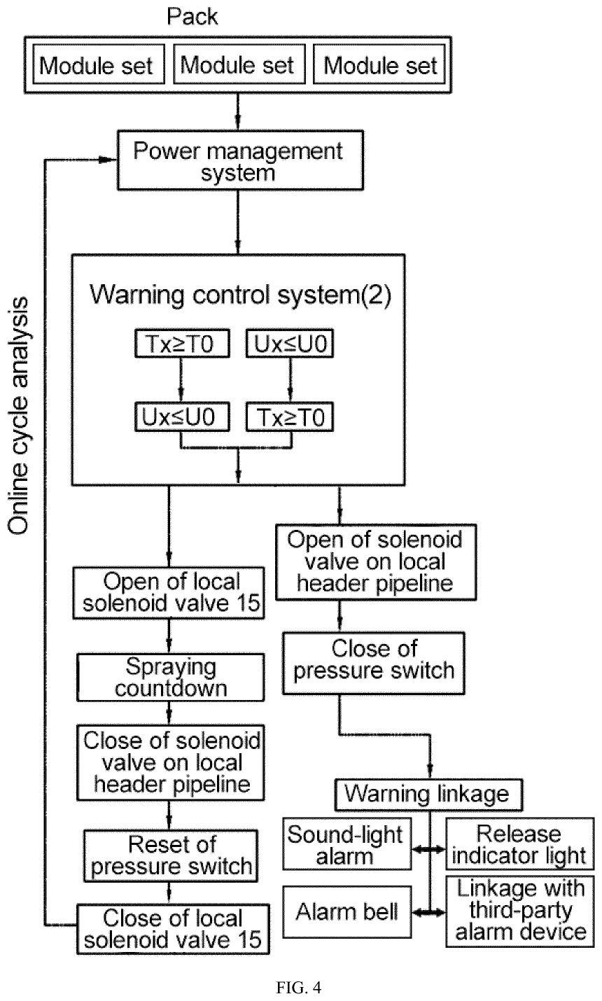

FIG. 4 schematically shows a work flow of a first-stage warning of the fire extinguishing system according to an embodiment of the present disclosure.

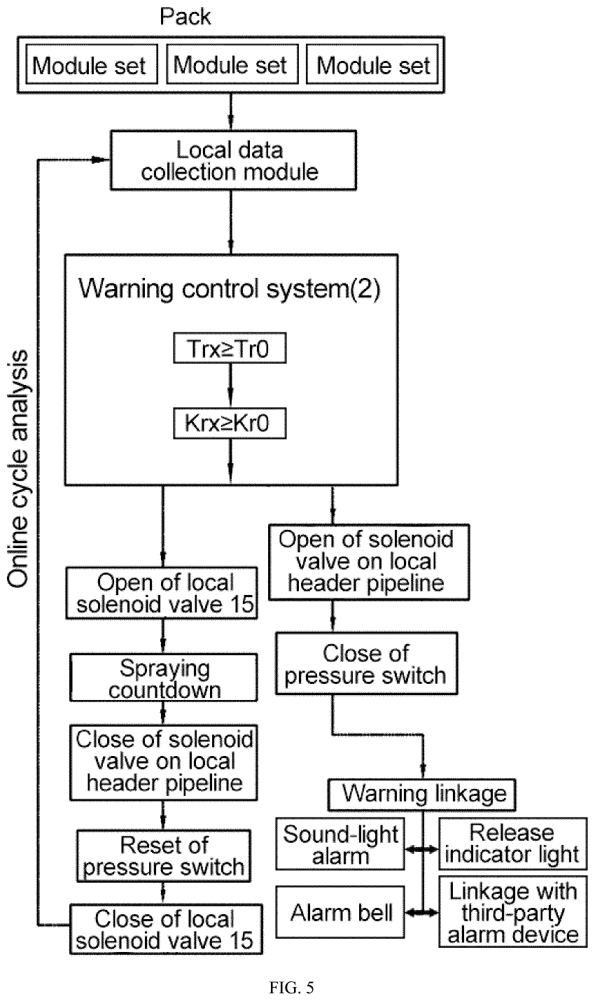

FIG. 5 schematically shows a work flow of a second-stage warning of the fire extinguishing system according to an embodiment of the present disclosure.

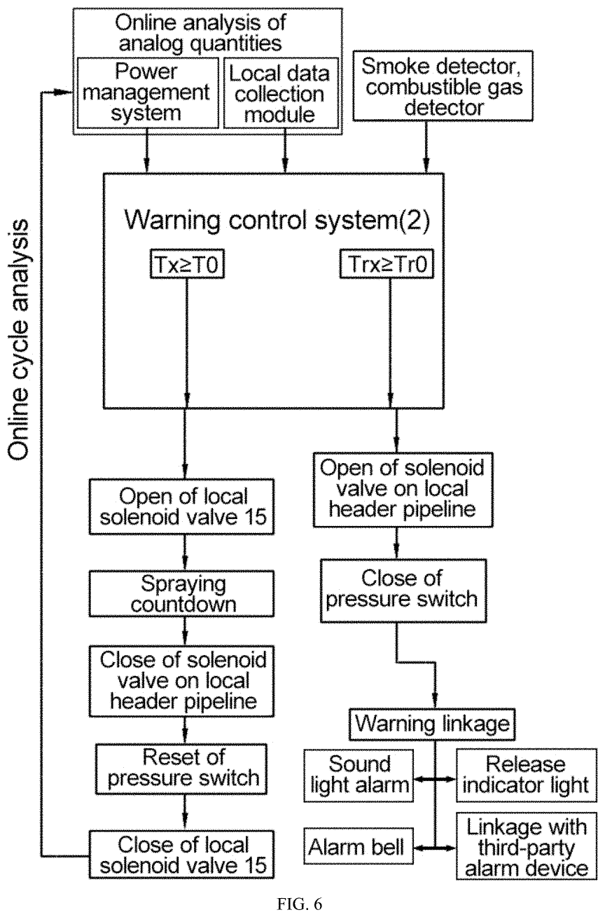

FIG. 6 schematically shows a work flow of a third-stage warning of the fire extinguishing system according to an embodiment of the present disclosure.

### DETAILED DESCRIPTION OF EMBODIMENTS

As shown in FIGS. 1-3, a fire extinguishing system for a lithium battery energy storage unit based on stagewise warning and multiple spraying includes a power management system 1, a warning control system 2 connected to the power management system 1 and a fire extinguishing device 3 connected to the warning control system 2. The fire extinguishing device 3 is externally connected to a temperature-sensing fire detection tube 4, a large-flow release pipeline 5 and a local release pipeline 6. The warning control system 2 is externally connected to a local data collection module 7 and a lithium battery energy storage pack 9.

In an embodiment, the power management system 1 is configured to collect a temperature T and a voltage U of a cell in the lithium battery energy storage pack 9 in real time and transmit the temperature T and the voltage U to the warning control system 2.

In an embodiment, the warning control system 2 is configured as an operation and processing center of the fire extinguishing system. The warning control system 2 is configured to collect internal data of the power management system 1 to analyze temperature and voltage data of a cell of the lithium battery energy storage pack 9, collect data of the local data collection module 7 to indirectly collect thermal runaway temperature data of thermal runaway of the lithium battery energy storage pack 9 and collect a fire alarm signal sent from a smoke alarm 10, a combustible gas detector 11 and a manual control module 12 to control actuation of the fire extinguishing device 3 and output of a signal linkage module 13 through a series of logical operations.

In an embodiment, the fire extinguishing device 3 is provided with a plurality of solenoid valves. The plurality of solenoid valves are configured to be switched on and off according to an instruction of the warning control system 2 to selectively release a fire extinguishing agent from the fire extinguishing device 3.

In an embodiment, the temperature-sensing fire detection tube 4 is a temperature-sensitive pressure-resistant hose. A burst temperature of the temperature-sensing fire detection tube 4 is 120-180° C. An inside of the temperature-sensing fire detection tube 4 is configured to transport the fire extinguishing agent. A bearable pressure of the temperature-sensing fire detection tube 4 is 5-10 MPa.

In an embodiment, the local release tube 8 is provided near the lithium battery energy storage pack 9. The warning control system 2 is configured to send an actuating instruction and the fire extinguishing agent to be released from the local release tube 8 to enter the lithium battery energy storage 9 to perform fire extinguishment. In an embodiment, the local data collection module 7 is configured to convert a single point signal of a thermal runaway sensor into a bus signal with address and transmit the bus signal to the warning control system 2 through RS485, CAN and Ethernet. The warning control system 2 is configured to set a control signal of the plurality of solenoid valves through the RS485, CAN and Ethernet to control the plurality of solenoid valves to be switched on and off, so as to achieve point-to-point signal collection and control of the plurality of solenoid valves.

In an embodiment, the combustible gas detector 11 is configured to detect a combustible gas released by thermal runway of a lithium battery. The combustible gas is carbon monoxide, hydrogen or a combination thereof. When the combustible gas reaches a preset concentration, a fire warning signal is output.

In an embodiment, the manual control module 12 is provided with a starting switch and a reset switch. When a fire is observed, the starting switch is manually pressed to allow the warning control system 2 directly start the fire extinguishing device 3 to directly release the fire extinguishing agent through the large-flow release pipeline 5. When an operation is required to be canceled, the reset switch is manually pressed to reset all operations and alarms.

In an embodiment, the signal linkage module 13 is configured to have a linkage with a third-party alarm device when the fire extinguishing agent is released. The third-party alarm device includes a sound-light alarm, an alarm bell, a fire extinguishing agent and a release indicator light.

In an embodiment, the temperature-sensing fire detection tube 4 is a hose, on which a burst will appear when a set temperature is reached. Specifically, when the lithium battery energy storage pack 9 reaches the set temperature, the burst will be formed on the fire detection tube 4 and a pressure in the fire detection tube 4 is released through the burst. At this time, after the fire extinguishing device 3 is started, one part of the fire extinguishing agent is released from the burst to accurately extinguish the fire and the other part of the fire extinguishing agent is released through the large-flow release pipeline 5 for pure temperature-sensing emergency start protection.

Described below is a fire extinguishing method using the above fire extinguishing system.

First-Stage Warning

The first-stage warning is performed based on a linkage between the warning control system 2 and the power management system 1.

(1) The warning control system 2 collects the temperature and the voltage of the cell in the lithium battery energy storage pack 9 in real time through the power management system 1.

(2) The warning control system 2 analyzes conditions of the thermal runaway of the lithium battery energy storage pack 9, that is, Tx≥T0 and Ux≤U0, where T0 is a boundary temperature of the thermal runaway and U0 is a boundary voltage of the thermal runaway.

(3) The warning control system 2 outputs an instruction to the fire extinguishing device 3 to switch on a solenoid valve on a local header pipeline 6 and a local solenoid valve 15, so as to release the fire extinguishing agent.

(4) A reset instruction is given after the fire extinguishing device 3 releases the fire extinguishing agent, and the warning control system 2 resets all solenoid valves on the fire extinguishing device 3 to complete one release of the fire extinguishing agent, where the duration of one release of the fire extinguishing agent is determined according to actual engineering needs. When the warning control system 2 again detects through the power management system 1 that the temperature and voltage meet the boundary conditions of the thermal runaway, steps (2-4) are repeated to achieve multiple spraying of the fire extinguishing agent.

Second-Stage Warning

The second-stage warning is performed based on a linkage of the warning control system 2 and the thermal runaway sensor 14.

(1) The warning control system 2 collects data of the thermal runaway sensor 14 in real time through the local data collection module 7.

(2) The warning control system 2 analyzes the data of the thermal runaway sensor 14 to determine whether the lithium battery energy storage pack 9 meets boundary conditions of the thermal runaway, that is, Trx≥Tr0 and Krx≥Kr0, where Tr0 is a boundary temperature of the environment of the pack and Kr0 is a heating rate of the ambient temperature of the pack when the thermal runaway occurs in the battery.

(3) The warning control system 2 outputs an instruction to the fire extinguishing device 3 to start the solenoid valve on the local header pipeline 6 and the local solenoid valve 15, so as to release the fire extinguishing agent.

(4) A reset instruction is given after the fire extinguishing device 3 releases the fire extinguishing agent, and the warning control system 2 resets all solenoid valves on the fire extinguishing device 3 to complete one release of the fire extinguishing agent, where the duration of one release of the fire extinguishing agent is determined according to actual engineering needs. When the warning control system 2 again detects through the local data collection module 7 that the temperature and heating rate meet the boundary conditions of the thermal runaway, steps (2-4) are repeated to achieve multiple spraying of the fire extinguishing agent.

Third-Stage Warning

The warning control system 2 determines whether there is a fire hazard through the smoke detector 10 and the combustible gas detector 11, and then comprehensively analyzes the fire hazard and the specific location thereof through the temperature signal Tx of the power management system 1 and Trx signal of the thermal runaway sensor 14. The specific operation is described as follows.

(1) The warning control system 2 determines the existence of fire hazard through the smoke detector 10 and the combustible gas detector 11.

(2) The warning control system 2 detects the cell temperature Tx≥T0 or Trx≥Tr0 and locates the fire in the x^{th} pack.

(3) The warning control system 2 outputs an instruction to the fire extinguishing device 3 to start the solenoid valve on the local header pipeline 6 and the x^{th} local solenoid valve 15, so as to release the fire extinguishing agent.

(4) A reset instruction is given after the fire extinguishing device 3 releases the fire extinguishing agent, so that the warning control system 2 resets all solenoid valves on the fire extinguishing device 3 to complete one release of the fire extinguishing agent, where the duration of one release of the fire extinguishing agent is determined according to actual engineering needs. When the warning control system 2 again detects that the temperature meets the boundary conditions of the thermal runaway, steps (2-4) are repeated to achieve multiple spraying of the fire extinguishing agent. The above are only preferred embodiments of this application, but not all embodiments. Any changes and replacement made by those skilled in the art within the spirit and principle of this application shall fall within the protection scope of this application.

What is claimed is:

1. A fire extinguishing system for a lithium battery energy storage unit based on stagewise warning and multiple spraying, comprising:
a power management system;
a warning control system connected to the power management system; and
a fire extinguishing device connected to the warning control system;
wherein the fire extinguishing device is externally connected to a temperature-sensing fire detection tube, a large-flow release pipeline and a local release pipeline; and the warning control system is externally connected to a local data collection module and a lithium battery energy storage pack.

2. The fire extinguishing system of claim 1, wherein the power management system is configured to collect a temperature T and a voltage U of a cell in the lithium battery energy storage pack in real time and transmit the temperature T and the voltage U to the warning control system.

3. The fire extinguishing system of claim 1, wherein the warning control system is configured as an operation and processing center of the fire extinguishing system; and the warning control system is configured to collect internal data of the power management system to analyze temperature and voltage data of a cell of the lithium battery energy storage pack, collect data of the local data collection module to indirectly collect temperature data of thermal runaway of the lithium battery energy storage pack and collect a fire alarm signal sent from a smoke alarm, a combustible gas detector and a manual control module to control actuation of the fire extinguishing device and output of a signal linkage module through a series of logical operations.

4. The fire extinguishing system of claim 1, wherein the fire extinguishing device is provided with a plurality of solenoid valves; the plurality of solenoid valves are configured to be switched on and off according to an instruction of the warning control system to selectively release a fire extinguishing agent from the fire extinguishing device.

5. The fire extinguishing system of claim 1, wherein the temperature-sensing fire detection tube is a temperature-sensitive pressure-resistant hose; a burst temperature of the temperature-sensing fire detection tube is 120-180° C.; an inside of the temperature-sensing fire detection tube is configured to transport a fire extinguishing agent; and a bearable pressure of the temperature-sensing fire detection tube is 5-10 MPa.

6. The fire extinguishing system of claim 1, wherein a rear end of the local release pipeline is connected to a local release tube; the local release tube is provided near the lithium battery energy storage pack; and the warning control system is configured to send an actuating instruction to allow a fire extinguishing agent to be released from the local release tube to enter the lithium battery energy storage to perform fire extinguishment.

7. The fire extinguishing system of claim 1, wherein the local data collection module is configured to convert a single point signal of a thermal runaway sensor into a bus signal with address and transmit the bus signal to the warning control system through RS485, CAN and Ethernet; and the warning control system is configured to set a control signal of a plurality of solenoid valves through the RS485, CAN and Ethernet to control the plurality of solenoid valves to be switched on and off, so as to achieve point-to-point signal collection and control of the plurality of solenoid valves.

8. The fire extinguishing system of claim 3, wherein the combustible gas detector is configured to detect a combustible gas released by thermal runway of a lithium battery; the combustible gas is carbon monoxide, hydrogen and a combination thereof; and when the combustible gas reaches a preset concentration, a fire warning signal is output.

9. The fire extinguishing system of claim 3, wherein the manual control module is provided with a starting switch and a reset switch; when a fire is observed, the starting switch is manually pressed to allow the warning control system to directly start the fire extinguishing device to directly release a fire extinguishing agent through a large-flow release pipeline; and when an operation is required to be canceled, the reset switch is manually pressed to reset all operations and alarms.

10. The fire extinguishing system of claim 3, wherein the signal linkage module is configured to have a linkage with a third-party alarm device when a fire extinguishing agent is released; and the third-party alarm device comprises a sound-light alarm, an alarm bell, the fire extinguishing agent and a release indicator light.
